(19) United States
(12) Patent Application Publication
(10) Pub. No.: US 2025/0062320 A1
(43) Pub. Date: Feb. 20, 2025

(54) Li-BASED COMPOSITE ANODE FOR A SOLID STATE BATTERY AND METHOD OF MANUFACTURE THEREOF

(71) Applicant: GM GLOBAL TECHNOLOGY OPERATIONS LLC, Detroit, MI (US)

(72) Inventors: Yong Lu, Shanghai (CN); Zhe Li, Shanghai (CN); Qili Su, Shanghai (CN); Haijing Liu, Shanghai (CN)

(21) Appl. No.: 18/480,632

(22) Filed: Oct. 4, 2023

(30) Foreign Application Priority Data
Aug. 18, 2023 (CN) 202311050321.8

(51) Int. Cl. H01M 4/36; H01M 4/04; H01M 4/134; H01M 4/136; H01M 4/1395; H01M 4/1397; H01M 4/38; H01M 4/525; H01M 4/58; H01M 10/052; H01M 10/0562; H01M 10/058

(52) U.S. Cl. CPC H01M 4/366; H01M 4/0404; H01M 4/134; H01M 4/136; H01M 4/1395; H01M 4/1397; H01M 4/382; H01M 4/525; H01M 4/5815; H01M 10/052; H01M 10/0562; H01M 10/058; H01M 2004/021; H01M 2004/027; H01M 2300/0068

(57) ABSTRACT

A solid state battery cell includes an anode, a cathode, and a solid state electrolyte disposed between the anode and the cathode. The anode is a lithium metal composite anode that comprises a lithium metal layer and a metal sulfide. A method of manufacturing a battery cell includes disposing a lithium metal composite anode on an anode current collector, where the lithium metal composite anode comprises a lithium metal layer and a metal sulfide. A solid state electrolyte is then disposed on the lithium metal composite anode. A cathode active layer is disposed on the solid state electrolyte and a cathode current collector is disposed on the cathode active layer.

### CROSS-REFERENCE TO RELATED APPLICATIONS

This application claims priority to Chinese Patent Application No. 202311050321.8, filed Aug. 18, 2023, and all the benefits accruing therefrom under 35 U.S.C. § 119, the contents of which in its entirety are herein incorporated by reference.

### INTRODUCTION

The subject disclosure relates to a solid state battery and method of manufacture thereof. In particular, it is directed to a lithium-based composite anode for a dendrite-free all solid state battery.

All-solid-state batteries (ASSB) that employ sulfide electrolytes have the potential to be better than state-of-the-art lithium-ion battery (LIB) in terms of abuse tolerance and working temperature range. For example, when thin lithium metal foils are used as anodes in ASSB, high energy densities can be achieved because of the relative high density of solid-state electrolytes (SSEs) compared with liquid electrolytes. Unfortunately, lithium dendrites often form during battery operation due to the heterogeneous deposition of lithium at the anode. These dendrites cause short-circuit risks and capacity loss for batteries. Specifically for a sulfide-based all solid-state battery (S-ASSB), if no pressure greater than 50 pounds per square inch is applied to enhance the grain boundary between the SSEs particles during operation, the cells develop lithium-dendrites which result in internal-shorting especially when the capacity loading is relatively high.

FIGS. 1A and 1B depict a lithium metal anode 12 in contact with a sulfide solid state electrolyte 10 before and after electrical cycling respectively. The lithium metal reacts with the sulfide solid state electrolyte to increase the interfacial resistance because of the occurrence of an interfacial side reaction product 14. The sulfide solid state electrolyte 10 is Li₆PS₅Cl. FIG. 1A is a photomicrograph that shows that there are no dendrites formed before cycling, while FIG. 1B is a photomicrograph that shows the formation of lithium dendrites 16 at grain boundaries after some cycling has occurred. Cracks 18 also occur in the solid state electrolyte, which increase cell resistance. Cells with high mass loading of cathode mixtures, comprising of cathode active materials, lithium sulfide electrolytes and conductive carbons (at loadings of 30 mg/cm²) cannot be fully charged even at the initial cycle at relative low temperature (e.g., 25° C.).

Accordingly, it is desirable to provide a lithium-based composite anode that is designed to suppress the formation of dendrites.

### SUMMARY

In an exemplary embodiment, a solid state battery cell includes an anode, a cathode, and a solid state electrolyte disposed between the anode and the cathode. The anode is a lithium metal composite anode that comprises a lithium metal layer and a metal sulfide.

In addition to one or more of the features described herein, the metal sulfide is disposed as a continuous layer on the lithium metal layer.

In yet another exemplary embodiment, the metal sulfide is in the form of particles partially embedded on a surface of the lithium metal layer.

In yet another exemplary embodiment, the metal sulfide is in the form of particles that are dispersed in a volume of the lithium metal layer.

In yet another exemplary embodiment, the metal sulfide is indium sulfide, aluminum sulfide, germanium sulfide, silicon sulfide, selenium sulfide, or a combination thereof.

In yet another exemplary embodiment, a thickness ratio of the continuous metal sulfide layer to that of the lithium metal layer varies from 0.01:1 to 0.5:1.

In yet another exemplary embodiment, the continuous metal sulfide layer has a thickness of 0.001 micrometers to 50 micrometers.

In yet another exemplary embodiment, the metal sulfide particles are disposed on the lithium metal layer in an amount effective to cover an area of 10 to 90 percent of a total surface area of the lithium metal layer.

In yet another exemplary embodiment, the metal sulfide particles dispersed in the lithium metal layer occupy 1 to 50 percent of the total volume of the lithium metal composite anode.

In yet another exemplary embodiment, the cathode includes a cathode current collector in electrical communication with a cathode active layer; where the cathode active layer comprises a cathode active material, an electrically conductive additive, the solid state electrolyte and a polymeric binder.

In yet another exemplary embodiment, the cathode active material is lithium cobalt oxide, lithium nickel manganese cobalt oxide, lithium nickel manganese oxide, lithium nickel cobalt aluminum oxide, lithium iron phosphate oxide, lithium nickel cobalt aluminum oxide, spinel, or a combination thereof.

In yet another exemplary embodiment, the lithium nickel manganese cobalt oxide is LiNiₓMn_{y}Co_{(1-x-y)}O₂; the lithium nickel cobalt aluminum oxide is LiNiₓMn_{y}Al_{(1-x-y)}O₂, the lithium nickel manganese oxide is LiNiₓMn₍₁₋ₓ₎O₂, wherein each case x is 0.7 to 0.85, an y is less than 0.15.

In yet another exemplary embodiment, the solid state electrolyte includes a Li₂S—P₂S₅ system, a Li₂S—SnS₂ system, a Li₂S—SiS₂ system, a Li₂S—GeS₂ system, a Li₂S—B₂S₃ system, a Li₂S—Ga₂S₃ system, a Li₂S—P₂S₃ system, a Li₂S—Al₂S₃ system, a Li₂O—Li₂S—P₂S₅ system, a Li₂S—P₂S₅—P₂O₅ system, a Li₂S—P₂S₅—GeS₂ system, a Li₂S—P₂S₅—LiX system, where X═F, Cl, Br or I; a Li₂S—As₂S₅—SnS₂ system, a Li₂S—P₂S₅—Al₂S₃ system, a Li₂S—LiX—SiS₂, where X═F, Cl, Br or I.

In an exemplary embodiment, a method of manufacturing a battery cell includes disposing a lithium metal composite anode on an anode current collector, where the lithium metal composite anode comprises a lithium metal layer and a metal sulfide. A solid state electrolyte is then disposed on the lithium metal composite anode. A cathode active layer is disposed on the solid state electrolyte and a cathode current collector is disposed on the cathode active layer.

In addition to one or more of the features described herein, the metal sulfide is disposed as a continuous layer on the lithium metal layer.

In yet another exemplary embodiment, the metal sulfide is in the form of particles partially embedded on a surface of the lithium metal layer.

In yet another exemplary embodiment, the metal sulfide is in the form of particles that are dispersed in a volume of the lithium metal layer.

In yet another exemplary embodiment, the metal sulfide is indium sulfide, aluminum sulfide, germanium sulfide, silicon sulfide, selenium sulfide, or a combination thereof.

In yet another exemplary embodiment, a thickness ratio of the continuous metal sulfide layer to that of the lithium metal layer varies from 0.01:1 to 0.5:1.

In yet another exemplary embodiment, the continuous metal sulfide layer has a thickness of 0.001 micrometers to 50 micrometers.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1A is a photomicrograph that shows that there are no dendrites formed before cycling;

FIG. 1B is a photomicrograph that shows the formation of lithium dendrites at grain boundaries after some cycling has occurred;

FIG. 2A is a depiction of an exemplary multilayered lithium metal composite anode;

FIG. 2B is a depiction of a lithium metal composite anode where the metal sulfide particles are partially embedded in the lithium metal layer;

FIG. 2C is a depiction of a lithium metal composite anode where the metal sulfide particles are dispersed through the volume of the lithium metal layer;

FIG. 3 is a depiction of an exemplary method of disposing the metal sulfide particles on a surface of the lithium metal layer; and

FIG. 4 is a graph of charge-discharge curves where voltage is plotted versus capacity at loadings of 10 mg/cm² and 30 mg/cm².

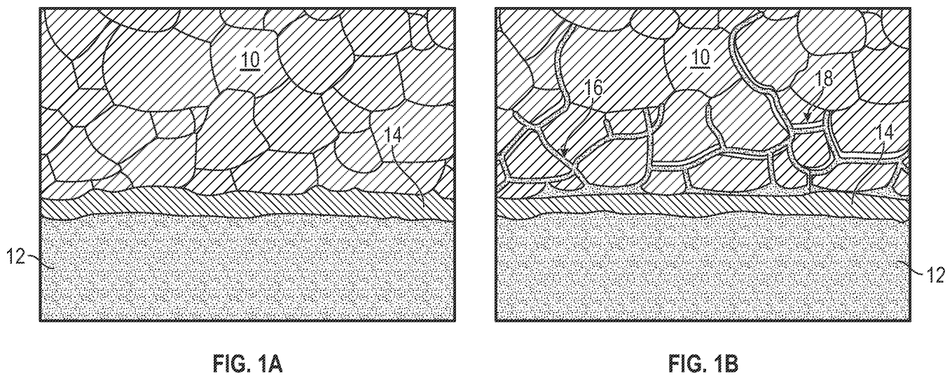

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with an exemplary embodiment, disclosed herein is an anode composition that comprises lithium metal with a metal sulfide. The metal sulfide may be disposed in the form of a continuous layer on a surface of the lithium metal, embedded on a surface of the lithium metal or dispersed within a volume of lithium metal in the anode composition. In an embodiment, the metal sulfide reacts with the lithium metal to produce lithium sulfide and an alloy of lithium and the metal. This results in a reduction of the formation of dendrites during battery operation. The reduction in dendrite formation minimizes shorting and improves cell capacity.

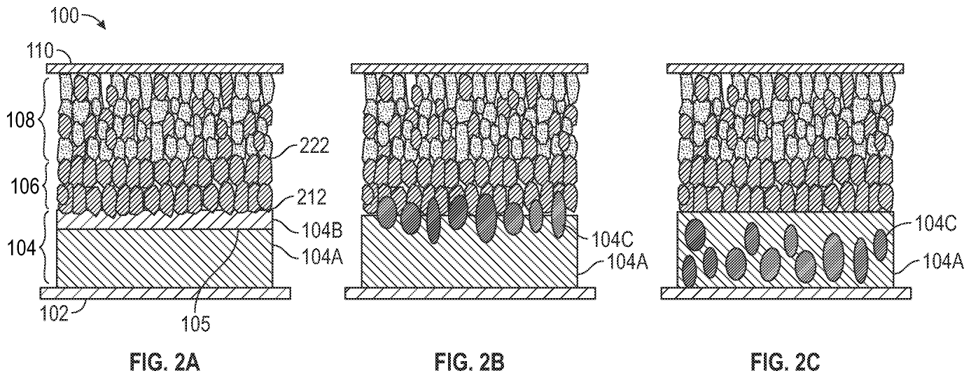

FIGS. 2A, 2B and 2C depict three exemplary embodiments of a cross-sectional area of a solid state battery cell that uses a sulfide solid state electrolyte. The same numerals are used to indicate the same components in all of the battery cells in the FIGS. 2A, 2B and 2C. Each battery cell 100 in the FIGS. 2A, 2B and 2C comprises an anode current collector 102, a lithium metal composite anode 104 that comprises a lithium metal layer 104A that is in contact with a metal sulfide 104B. The lithium anode 104 contacts a first surface of the solid state electrolyte layer 106. An opposing second surface of the solid state electrolyte layer 106 contacts a cathode active layer 108, which in turn contacts the cathode current collector 110. The anode of the battery cell 100 therefore comprises an anode current collector 102 and a lithium metal composite anode 104. The cathode of the battery cell 100 therefore comprises a cathode current collector 110 and a cathode active layer 108.

FIGS. 2A, 2B and 2C depict different arrangements of the lithium metal composite anode 104. In the FIG. 2A, the lithium metal composite anode is a multilayered anode with metal sulfide layer 104B disposed on the lithium metal layer 104A. In the FIG. 2B, the metal sulfide is in the form of particles 104C (hereinafter metal sulfide particles 104C) that are dispersed on a surface of the lithium metal layer 104A. In the FIG. 2B, the metal sulfide particles 104C may be partially embedded in the surface of the lithium metal layer 104A. In the FIG. 2C, the metal sulfide particles 104C are completely embedded in the volume of the lithium metal layer 104A. It is to be noted that arrangements involving combinations of the configurations of those depicted in the FIGS. 2A, 2B and 2C are also contemplated here, even though they may not be detailed explicitly. For example, the configuration of the FIG. 2B may be combined with the configuration of 2C (not shown here), such that the metal sulfide particles 104C may be dispersed on the surface of the lithium metal layer 104A as well as through the volume of the lithium metal layer 104A. Alternatively, the configuration of the FIG. 2A may be combined with the configuration of FIG. 2C such that the metal sulfide layer 104B is disposed on a surface of the lithium metal layer 104A, while at the same time metal sulfide particles 104C are disposed throughout the volume of the lithium metal layer 104A.

With reference now to the FIG. 2A, the anode current collector 102 is generally a metal film or a metal mesh that comprises copper, nickel, stainless steel, or a combination thereof. The anode current collector 102 has disposed on it a lithium metal composite anode 104 that that comprises a lithium metal layer 104A and a metal sulfide layer 104B. With reference now to the FIG. 2A, the lithium metal layer 104A comprises only lithium metal of a thickness of 0.1 to 100 micrometers. The lithium metal layer 104A contacts the anode current collector 102 directly. Disposed on the lithium metal layer 104A is a metal sulfide layer 104B. The lithium metal layer 104A contacts the metal sulfide layer 104B at a single interface 105.

The metal sulfide layer 104B has a smaller thickness than that of the lithium metal layer 104A. In an embodiment, the thickness ratio of the metal sulfide layer 104B to that of the lithium metal layer 104A varies from 0.01:1 to 0.5:1. The metal sulfide layer 104B has a thickness of 0.001 micrometers to 50 micrometers.

With reference now to the FIG. 2B it may be seen that the metal sulfide particles 104C are partially embedded in the lithium metal layer 104A. In other words, the lithium metal layer 104A has its surface modified by the presence of the metal sulfide particles 104C. In this embodiment, a plurality of the metal sulfide particles 104C protrude from a surface of the lithium metal layer 104A. A remaining portion of the metal sulfide particles 104C protrude into the surface of the lithium metal layer 104A. Some of the metal sulfide particles 104C may be disposed on a surface of the lithium metal layer 104A without actually being embedded in the metal layer 104A. The metal sulfide particles 104C have average particle diameters of 50 to 20,000 nanometers. The particle diameter referred to herein is the diameter of the cross-section of the particles as measured using scanning electron microscopy. In order to determine average particles size, a plurality of particles are imaged using a scanning electron microscope and then the average diameter is calculated by adding up all the diameters and dividing the sum by the total number of particles. The metal sulfide particles 104C are disposed on the lithium metal layer 104A in an amount effective to cover an area of 10 to 90 percent of the total surface area of the lithium metal layer 104A. In an embodiment, the thickness of the lithium metal layer 104A (containing the metal sulfide particles 104C) may be increased because the thickness has to accommodate both the volume of lithium metal as well as the volume of metal sulfide particles 104C.

FIG. 2C depicts an alternative embodiment, where the lithium metal layer 104A has embedded within its volume metal sulfide particles 104C. In this embodiment, the metal sulfide particles 104C are completely embedded in the lithium metal layer 104A and preferably do not protrude from its surfaces. The metal sulfide particles 104C embedded in the lithium metal layer 104A occupy 1 to 50 percent, preferably 5 to 35 percent of the total volume of the lithium metal composite anode 104.

The metal sulfides used in the metal sulfide layer 104B or in the metal sulfide particles 104C include indium sulfide, aluminum sulfide, germanium sulfide, silicon sulfide, selenium sulfide, or a combination thereof.

The metal sulfide layer 104B or the metal sulfide particles 104C may be combined with the lithium metal layer 104A in several different ways to form the lithium metal composite anode 104. These are briefly detailed below.

In an embodiment, the metal sulfide layer 104B may be disposed on a lithium meta layer 104A via physical vapor deposition. A layer of lithium metal 104A is first disposed on the anode current collector 102, following which a magnetron may be used to sputter a layer of the metal sulfide 104B of the desired thickness on the lithium metal layer 104A to form the lithium metal composite anode 104. In another embodiment, the lithium metal layer 104A may be evaporated onto a metal sulfide layer 104B. In this embodiment, a film of metal sulfide of the desired thickness is used as a substrate on to which is evaporated the lithium metal layer 104A to form the lithium metal composite anode 104.

In another embodiment, a slurry of the metal sulfide is prepared using a solvent and an optional binder. The slurry is then disposed (coated or painted) onto the lithium metal layer 104A and subjected to drying to form metal sulfide layer 104B. The result is the metal sulfide layer 104B disposed on the lithium metal layer 104A forming the lithium metal composite anode 104.

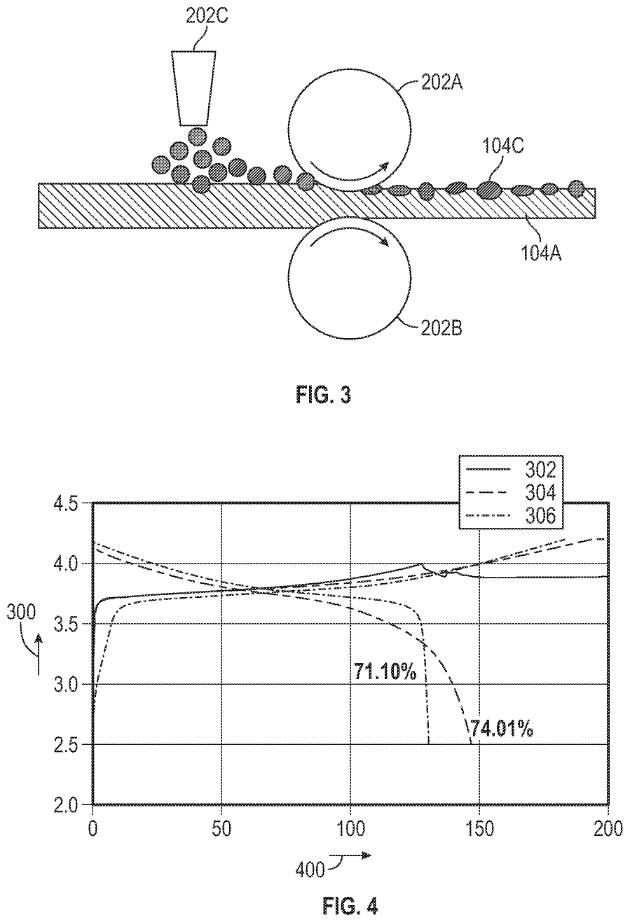

FIG. 3 depicts one exemplary embodiment of manufacturing the lithium metal composite anode 104, where the metal sulfide particles 104C are partially embedded in a surface of the lithium metal layer 104A. This embodiment is depicted in the FIG. 2B above. A spray system 202C filled with the metal sulfide particles 104C (or a suspension of the metal sulfide particles) discharges the particles onto a sheet of lithium metal 104A. A pair of roll mills 202A and 202B apply a combination of shear and compressive forces on the metal sulfide particles 104C thus partially embedding them in the lithium metal layer 104A and forming the lithium metal composite anode 104.

In another embodiment, the metal sulfide particles 104C may be completely embedded in the lithium metal layer 104A (to produce the lithium metal composite anode 104 of the FIG. 2C) by first mixing the metal sulfide particles 104C with lithium metal particles to form a particle mixture. The particle mixture is heated to a temperature above the lithium melting point (357° F.) and then subjected to casting. Since the metal sulfide particles melt at higher temperatures (indium sulfide melts at 1922° F.) than that of the lithium metal, they do not undergo any change in state. The melt with the metal sulfide particles dispersed therein is then cast on a substrate (or in a mold) and subjected to cooling to form the lithium metal composite anode 104 (depicted in the FIG. 2C). Even if the metal sulfide particles melt at a lower temperature than the lithium metal, the configuration depicted in the FIG. 2C can still be produced so long as the metal sulfide molten particles remain dispersed in the molten lithium metal.

The following descriptions details the manufacturing and testing of a solid state battery that has the lithium metal composite anode 104 depicted in the FIGS. 2A, 2B and 2C. With reference now again to the FIGS. 2A, 2B and 2C, following the manufacturing of the lithium metal composite anode 104 as detailed above, the lithium metal composite anode 104 is disposed on the anode current collector 102. A solid state electrolyte layer 106 is disposed on the lithium metal composite anode 104 on a surface 222 that is opposed to the surface 212 that contacts the anode current collector 102.

The solid state electrolyte layer 106 comprises a solid state electrolyte that is combined with a polymeric binder. The solid state electrolyte generally comprises a pseudobinary sulfide, a pseudoternary sulfide, a pseudoquarternary sulfide, or a combination thereof. Examples of pseudobinary sulfides include the Li₂S—P₂S₅ system (e.g., Li₃PS₄, Li₇P₃S₁₁ and Li_{9.6}P₃Si₂), the Li₂S—SnS₂ system (e.g., Li₄SnS₄), the Li₂S—SiS₂ system, the Li₂S—GeS₂ system, the Li₂S—B₂S₃ system, the Li₂S—Ga₂S₃ system, the Li₂S—P₂S₃ system, the Li₂S—Al₂S₃ system, or a combination thereof. Examples of pseudoternary sulfides include the Li₂O—Li₂S—P₂S₅ system, the Li₂S—P₂S₅—P₂O₅ system, the Li₂S—P₂S₅—GeS₂ system (e.g., Li_{3.25}Ge_{0.25}P_{0.75}S₄ and Li₁₀GeP₂Si₂), the Li₂S—P₂S₅—LiX system (where X═F, Cl, Br, or I, examples of which include Li₆PS₅Br, Li₆PS₅Cl, L₇P₂S₈I and Li₄PS₄I), the Li₂S—As₂S₅—SnS₂ system (e.g., Li_{3.833}Sn_{0.833}As_{1.166}S₄), the Li₂S—P₂S₅—Al₂S₃ system, Li₂S—LiX—SiS₂ (where X═F, Cl, Br or I, which includes examples 0.4LiI—0.6Li₄SnS₄ and Li₁₁Si₂PS₁₂.

A preferred solid state electrolyte is Li₆PS₅Cl. The solid state electrolyte is present in the solid state electrolyte layer 106 in an amount of greater than 80 wt %, preferably greater than 90 wt %, preferably greater than 98 wt %, and more preferably 100 wt %, based on the total weight of the electrolyte layer 106. The electrolyte layer 106 may optionally contain a binder that facilitates bonding the solid state electrolyte particles together such that they do not get dispersed in the solid state battery and such that the shape of the solid state electrolyte layer 106 is retained.

The polymeric binder generally comprises an organic polymer. Examples of organic polymer include poly(tetrafluoroethylene) (PTFE), styrene ethylene butylene styrene copolymer (SEBS), styrene butadiene styrene copolymer (SBS), acrylonitrile butadiene rubber (NBR), styrene-butadiene rubber (SBR), poly(propylene carbonate) PPC, sodium carboxymethyl cellulose (CMC), poly(vinylidene fluoride) (PVDF), poly(vinylidene fluoride-co-hexafluoropropylene) (PVdF-HFP), polyacrylonitrile (PAN), poly(vinylidene fluoride-co-chlorotrifluoroethylene) (P(VDF-CTFE)), poly(vinylidene fluoride-trifluoroethylene) (P(VDF-TeFE)), poly(vinylidene fluoride-trifluoroethylene-chlorofluoroethylene) terpolymer (P(VDF-TrFE-CFE)), or a combination thereof. In a preferred embodiment, the polymeric binder used in the active layer is poly(vinylidene fluoride-hexafluoropropylene) copolymer. The polymeric binder has a weight average molecular weight of 5,000 to 1,000,000 grams per mole, preferably 50,000 to 750,000 grams per mole, and more preferably 75,000 to 500,000 grams per mole measured using gel permeation chromatography with a polystyrene standard.

The polymeric binder is optional and if used, is present in an amount of less than 20 wt %, preferably less than 10 wt %, and more preferably less than 1 wt % in the solid state electrolytic layer 106.

Disposed on an opposing surface 222 of the solid state electrolytic layer 106 (from the surface 212 that contacts the lithium metal composite anode 104) is the cathode active layer 108, which in turn contacts the cathode current collector 110. The cathode active layer 108 comprises a cathode active material, an electrically conductive additive, a polymeric binder and optionally the solid state electrolyte.

Cathode active materials may include lithium cobalt oxide (LCO, sometimes called “lithium cobaltate” or “lithium cobaltite”—one variant of which is LiCoO₂); lithium nickel manganese cobalt oxide (NMC, with a variant formula of LiNiMnCo); lithium manganese oxide (LMO with variant formulas of LiMn₂O₄, Li₂MnO₃ and others); lithium nickel cobalt aluminum oxide (LiNiCoAlO₂ and variants thereof as NCA) and lithium titanate oxide (LTO, with one variant formula being Li₄Ti₅O₁₂); lithium iron phosphate oxide (LFP, with one variant formula being LiFePO₄), lithium nickel cobalt aluminum oxide (and variants thereof as NCA) as well as other similar other materials, spinel (LiMn₂O₄, LiNi_{0.5}Mn_{1.5}O₄), polyanion cathode (LiV₂(PO₄)₃), and other lithium transition-metal oxides. Surface-coated and/or doped cathode materials mentioned above. e.g., LiNbO₃-coated LiMn₂O₄ and Al-doped LiMn₂O₄, may also be used. Low voltage cathode materials, e.g., lithiated metal oxide/sulfide (e.g., LiTiS₂), lithium sulfide and sulfur, may also be used.

Other variants of the foregoing may be included. In some embodiments where NMC is used as an active material, nickel rich NMC may be used. For example, in some embodiments, the variant of NMC may be LiNiₓMn_{y}Co_{(1-x-y)}O₂, LiNiₓMn_{y}Al_{(1-x-y)}O₂, LiNiₓMn₍₁₋ₓ₎O₂, Li₁₊ₓMO₂, where x is equal to or greater than about 0.7, 0.75, 0.80, 0.85, or more and where y is less than 0.15, preferably less than 0.1, In some embodiments, NMC811 may be used, where in the foregoing formula x is about 0.8 and y is about 0.1.

The cathode active material may be used in the cathode active layer 108 respectively in an amount of 50 to 98 wt %, preferably 70 to 95 wt %, based on a total weight of the cathode active layer.

The solid state electrolytes that may be used in the cathode active layer 108 are listed above (in the section dealing with the solid state electrolyte layer 106) and will not be listed again in the interests of brevity. The solid state electrolyte may be used in the cathode active layer in an amount of up to 50 wt %, preferably less than 30 wt %, and more preferably less than 15 wt %, based on a total weight of the cathode active layer 108. In an embodiment, the solid state electrolyte may be used in the cathode active layer in an amount of 1 wt % or more, preferably 2 wt % or more, based on a total weight of the cathode active layer 108.

The cathode active layer 108 also contains an electrically conductive additive. The electrically conducting additive preferably comprises an electrically conducting carbonaceous material. Examples of electrically conducting carbonaceous materials include carbon nanotubes, carbon black, activated carbon, graphene, graphite, graphite oxide, carbon fibers, or the like, or a combination thereof. It is desirable for the electrically conducting composition to form an electrically conducting network that extends from a surface of the cathode current collector 110 to the surface of the solid state electrolyte layer 106.

Carbon nanotubes include single wall carbon nanotubes (SWNTs), double wall carbon nanotubes (DWNTs), multiwall carbon nanotubes (MWNTs), or a combination thereof and have diameters of 2 to 100 nanometers, preferably 10 to 50 nanometers. They have lengths of 20 to 10,000 nanometers, preferably 200 to 5000 nanometers. Aspect ratios greater than 10, preferably greater than 50 and more preferably greater than 100 are desirable.

Carbon black having a high surface area is preferred for use in the electrode. Carbon black (subtypes are acetylene black, channel black, furnace black, lamp black and thermal black) is a material produced by the incomplete combustion of coal and coal tar, vegetable matter, or petroleum products, including fuel oil, fluid catalytic cracking tar, and ethylene cracking in a limited supply of air. Carbon black is a form of paracrystalline carbon that has a high surface-area-to-volume ratio, albeit lower than that of activated carbon. Carbon black having a surface area of 50 to 1000 m²/gm may be used in the slurry that is used to form the electrode.

Activated carbon also called activated charcoal, is a form of carbon that has a surface area in excess of 3,000 m²/gm as determined by gas adsorption. It can be used in conjunction with other electrically conducting carbonaceous elements listed herewith. Examples of carbon black or activated carbon that can be used in the electrode-forming slurry are Keltjen™ Black or Super P.

Graphene is an allotrope of carbon consisting of a single layer of atoms arranged in a hexagonal lattice nanostructure. Graphene that is added to the slurry may be in the form of individual graphene sheets or in the form of a plurality of loosely connected graphene sheets. Each atom in a graphene sheet is connected to its three nearest neighbors by σ-bonds and a delocalised π-bond, which contributes to a valence band that extends over the whole sheet. This is the same type of bonding seen in carbon nanotubes and polycyclic aromatic hydrocarbons, and in fullerenes and glassy carbon. The valence band is touched by a conduction band, making graphene a semimetal with unusual electronic properties that are best described by theories for massless relativistic particles.

Graphite particles may also be used in the electrically conducting composition. Graphite is a natural manifestation of pure carbon with a hexagonal crystal structure that is arranged in several parallel levels, called graphene layers. In short, graphite particles comprise a plurality of graphene sheets that are arranged to be parallel to each other. This anisotropic structure gives the graphite special properties, such as electrical conductivity or a particular strength along the individual layers. It is extremely heat-resistant with a sublimation point of over 3,800° C., thermally highly conductive and chemically inert.

Graphite oxide (GO), sometimes called graphene oxide, graphitic oxide or graphitic acid, is a compound of carbon, oxygen, and hydrogen in variable ratios, obtained by treating graphite with strong oxidizers and acids for resolving of extra metals. The maximally oxidized bulk product is a yellow solid with a C:O ratio between 2.1:1 and 2.9:1, that retains the layer structure of graphite but with a much larger and irregular spacing. The bulk material spontaneously disperses in basic solutions or can be dispersed by sonication in polar solvents to yield monomolecular sheets, known as graphene oxide by analogy to graphene, the single-layer form of graphite. Graphene oxide sheets exist in the form of strong paper-like materials, membranes, thin films, and composite materials and can be used in the electrode-forming slurry that is used to prepare the electrodes.

Carbon fibers have diameters of 5 to 10 micrometers and are composed mostly of carbon atoms. They can have lengths greater than 1000 micrometers, preferably greater than 10,000 micrometers. The are produced by drawing pitch or polyacrylonitrile polymeric fibers under high pressures and temperatures of over 1500° C., preferably at temperatures greater than 2200° C. Carbon fibers are different from carbon nanotubes and do not have cylindrical graphene sheets arranged concentrically. The carbon fibers typically comprise high aspect ratio graphene sheets arranged to be in a parallel configuration with each other.

The aforementioned carbon nanotubes, carbon black, activated carbon, graphene sheets, graphite particles, graphite oxide particles, or a combination thereof may be used individually or in any combination to form an electrically conducting network. In an exemplary embodiment, the carbon nanotubes typically are used in the largest amount when compared with the other carbonaceous ingredients.

The cathode active layer 108 may contain the electrically conducting additive in an amount of up to 30 wt %, preferably less than 20 wt %, and more preferably less than 10 wt %, based on a total weight of the cathode active layer 108. In an embodiment, the cathode active layer 108 may contain the electrically conducting additive in an amount of 1 wt % or more.

A polymeric binder may also be used in the cathode active layer 108 to facilitate bonding of the active material particles, the electrically conducting additive and the optional solid state electrolyte. The polymeric binder facilitates shape retention for the cathode active layer 108 and prevents dispersion of the ingredients of the cathode active layer 108 through the battery. The polymeric binders are already listed above and will not be repeated here again in the interests of brevity. The polymeric binder is used in the cathode active layer 108 in an amount of up to 20 wt %, preferably less than 15 wt %, preferably less than 10 wt %, and more preferably less than 5 wt %, based on the total weight of the cathode active layer 108. In an embodiment, the cathode active layer 108 may contain the polymeric binder in an amount of 1 wt % or more, preferably 2 wt % or more.

In one embodiment, in one method of manufacturing the solid state battery, an anode current collector 102 (see FIG. 2A) has disposed on it a lithium anode composite layer 104 (in one of the forms depicted in the FIGS. 2A, 2B and/or 2C). The manufacturing of the lithium anode composite layer 104 is detailed above and will not be described in detail again.

The solid state electrolyte layer 106 and the cathode active layer 108 may then be disposed sequentially in the form of slurries on the lithium anode composite layer 104.

In order to prepare the slurries, the ingredients of the solid state electrolyte layer 106 or the ingredients of the cathode active layer 108 are mixed with a suitable solvent. The solvent is preferably one that does not interact with the solid state electrolyte. After preparing each slurry (one for the solid state electrolyte layer 106 and another for the cathode active layer 108), the respective slurries are disposed on the lithium metal composite anode in sequence and each slurry is subjected to drying before the next slurry is deposited. When the solid state electrolyte layer 106 and the cathode active layer 108 are both dried, the cathode current collector 110 is disposed on the cathode active layer 108 to form the solid state battery 100. The battery may be sealed in a housing (not shown) if desired.

The compositions and ingredients detailed along with the various methods of manufacturing are detailed in the following non-limiting examples.

### EXAMPLE

### Example 1

This example was conducted to determine the performance of a cell that has a lithium metal composite anode versus one whose anode only contained lithium metal. The lithium metal composite anode used herein was a multilayered anode of the type previously depicted in the FIG. 2A, where the lithium metal layer had a layer of a metal sulfide (in this case indium sulfide In₂S₃) disposed on it. The solid state electrolyte layer contained Li₆PS₅Cl. No polymer binder was used to manufacture the anode. The materials used in the anode were pressed in a compression mold at a pressure of 540 MPa to manufacture the anode.

The cathode active layer contained NCM 523 as the cathode active material. The solid-state electrolyte used in the cathode active layer Li₆PS₅Cl. The electrically conducting additive is Super P and the polymeric binder is polytetrafluoroethylene. These were used cathode active layer in the weight ratio as follows: NCM523:L₆PS₅Cl:SP:PTFE=5:4:0.4:0.094.

The comparative solid-state battery uses only lithium metal as the anode. The two batteries were identical except for the difference in the anodes (the inventive battery with the lithium metal composite anode and the comparative battery with the lithium metal anode). FIG. 4 shows a graph of charge-discharge curves where voltage (V) (300) is plotted versus capacity (mAh/gram) (400) at loadings of 10 mg/cm² and 30 mg/cm². The performance of three different batteries each with a different anode are shown in the graph of FIG. 4. Two of the batteries had anodes that contained only lithium metal (one had an anode containing a high loading of lithium metal (302) and the other an anode containing only a low level of lithium metal (306)). One of the batteries has the composite anode with a high level of lithium metal (304). From the results it can be seen that the battery with composite anode contributes to a higher capacity even with higher mass loading and is free of internal shorting.

The terms “a” and “an” do not denote a limitation of quantity, but rather denote the presence of at least one of the referenced item. The term “or” means “and/or” unless clearly indicated otherwise by context. Reference throughout the specification to “an aspect,” means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A solid state battery cell comprising:
an anode;
a cathode; and
a solid state electrolyte disposed between the anode and the cathode; where the anode is a lithium metal composite anode that comprises a lithium metal layer and a metal sulfide.

2. The battery cell of claim 1, where the metal sulfide is disposed as a continuous layer on the lithium metal layer.

3. The battery cell of claim 1, where the metal sulfide is in a form of particles partially embedded on a surface of the lithium metal layer.

4. The battery cell of claim 1, where the metal sulfide is in a form of particles that are dispersed in a volume of the lithium metal layer.

5. The battery cell of claim 1, where the metal sulfide is indium sulfide, aluminum sulfide, germanium sulfide, silicon sulfide, selenium sulfide, or a combination thereof.

6. The battery cell of claim 2, where a thickness ratio of the continuous layer of metal sulfide to that of the lithium metal layer varies from 0.01:1 to 0.5:1.

7. The battery cell of claim 2, where the continuous layer of metal sulfide has a thickness of 0.001 micrometers to 50 micrometers.

8. The battery cell of claim 3, where the particles are disposed on the lithium metal layer in an amount effective to cover an area of 10 to 90 percent of a total surface area of the lithium metal layer.

9. The battery cell of claim 4, where the particles dispersed in the volume of the lithium metal layer occupy 1 to 50 percent of the total volume of the lithium metal composite anode.

10. The battery of claim 1, where the cathode comprises a cathode current collector in electrical communication with a cathode active layer; where the cathode active layer comprises a cathode active material, an electrically conductive additive, the solid state electrolyte and a polymeric binder.

11. The battery of claim 10, where the cathode active material is lithium cobalt oxide, lithium nickel manganese cobalt oxide, lithium nickel manganese oxide, lithium nickel cobalt aluminum oxide, lithium iron phosphate oxide, lithium nickel cobalt aluminum oxide, spinel, or a combination thereof.

12. The battery of claim 10, where the lithium nickel manganese cobalt oxide is LiNiₓMn_{y}Co_{(1-x-y)}O₂; the lithium nickel cobalt aluminum oxide is LiNiₓMn_{y}Al_{(1-x-y)}O₂, the lithium nickel manganese oxide is LiNiₓMn₍₁₋ₓ₎O₂, wherein each case x is 0.7 to 0.85, an y is less than 0.15.

13. The battery of claim 1, where the solid state electrolyte includes a Li₂S—P₂S₅ system, a Li₂S—SnS₂ system, a Li₂S—SiS₂ system, a Li₂S—GeS₂ system, a Li₂S—B₂S₃ system, a Li₂S—Ga₂S₃ system, a Li₂S—P₂S₃ system, a Li₂S—Al₂S₃ system, a Li₂O—Li₂S—P₂S₅ system, a Li₂S—P₂S₅—P₂O₅ system, a Li₂S—P₂S₅—GeS₂ system, a Li₂S—P₂S₅—LiX system, where X═F, Cl, Br or I; a Li₂S—As₂S₅—SnS₂ system, a Li₂S—P₂S₅—Al₂S₃ system, a Li₂S—LiX—SiS₂, where X═F, Cl, Br or I.

14. A method of manufacturing a battery cell comprising:
disposing a lithium metal composite anode on an anode current collector; where the lithium metal composite anode comprises a lithium metal layer and a metal sulfide;
disposing a solid state electrolyte on the lithium metal composite anode;
disposing a cathode active layer on the solid state electrolyte; and
disposing a cathode current collector on the cathode active layer.

15. The method of claim 14, where the metal sulfide is disposed as a continuous layer on the lithium metal layer.

16. The method of claim 14, where the metal sulfide is in a form of particles partially embedded on a surface of the lithium metal layer.

17. The method of claim 14, where the metal sulfide is in a form of particles that are dispersed in a volume of the lithium metal layer.

18. The method of claim 14, where the metal sulfide is indium sulfide, aluminum sulfide, germanium sulfide, silicon sulfide, selenium sulfide, or a combination thereof.

19. The method of claim 15, where a thickness ratio of the continuous layer of metal sulfide to that of the lithium metal layer varies from 0.01:1 to 0.5:1.

20. The battery cell of claim 19, where the continuous layer of metal sulfide has a thickness of 0.001 micrometers to 50 micrometers.
